(19) United States
(12) Patent Application Publication
(10) Pub. No.: US 2009/0144240 A1
(43) Pub. Date: Jun. 4, 2009

(54) Method and systems for using community bookmark data to supplement internet search results

(75) Inventors: Vik Singh, San Jose, CA (US); Raghu Ramakrishnan, Los Altos, CA (US)

Correspondence Address: MPG, LLP AND YAHOO! INC., 710 LAKEWAY DRIVE, SUITE 200, SUNNYVALE, CA, 94085, US

(73) Assignee: Yahoo!, Inc., Sunnyvale, CA (US)

(21) Appl. No.: 11/950,397

(22) Filed: Dec. 4, 2007

(51) Int. Cl. G06F 17/30

(52) U.S. Cl. 707/3; 707/E17.114

(57) ABSTRACT

Methods and systems for generating overlay data to supplement search results obtained as a result of an internet search for a query provided by a user. The method includes accessing a universal resource locator (URL) database having URLs that are processed. The URL database has information regarding the number of times a URL in the URL database has been bookmarked and any descriptive tags assigned to specific URLs in the URL database. Then, receiving the query provided by the user that generates search results, where each search result is associated with a URL. The method further includes, before displaying the search results, analyzing each URL of a plurality of the search results to identify if the URL is present in the accessed URL database, and applying overlay data to particular ones of the search results. The overlay data includes information regarding the number of times the URL has been bookmarked and includes particular descriptive tags from the URL database. In one embodiment, a detailed sub-query is associated with each overlay descriptive tag that includes the original query and the overlay descriptive tag.

### BACKGROUND

The computing industry has seen many advances in recent years, and such advances have produced a multitude of products and services. Internet websites are examples of products and services, which are created to give users access to particular types of services, data, or searching capabilities. Online content providers are increasingly moving towards building World Wide Web sites which are more reliant on dynamic, frequently-updated content. Content continues to be made available more and more via online auction sites, stock market information sites, news and weather sites, or any other such site whose information changes on a frequent basis, oftentimes daily.

Typically, major search engines, which enable Internet users to search for information on the World Wide Web, create search databases of information which rely on pages being static instead of dynamic. To create these databases, the search engine does what is known as “crawling” web sites by retrieving the content of a given Web page and storing it for later use. These databases are extensive, and can be updated frequently by crawls to capture changes.

The search results from a general search take on a similar format, such as listings of links. These links provide general description of the websites that are found and sometimes provide a general abstract. The abstract are constructed from information that is parsed from the listed websites themselves, and are generally listed or associated next to the listed website links. Although the abstract provided to give users more information about the website links, the information provided in the abstracts are not always well constructed, or are pieced together in nonsensical ways. Consequently, users find it difficult to trust the information found in the abstracts. And, users are generally forced to click through the various links to fully understand if the websites contain the information that was intended by the user.

It is in this context that embodiments of the invention arise.

### SUMMARY

Embodiments of the present invention provide methods and systems for improving Internet search results by presenting community use data along with search results. The community use data is analyzed and overlaid for presentation with the search results, which in turn increase the trust given to the particular search results by users.

It should be appreciated that the present invention can be implemented in numerous ways, such as a process, an apparatus, a system, a device or a method on a computer readable medium. Several inventive embodiments of the present invention are described below.

In one embodiment, a computer implemented method for generating overlay data to supplement search results obtained as a result of an internet search for a query provided by a user is provided. The method includes accessing a universal resource locator (URL) database having URLs that are processed. The URL database has information regarding the number of times a URL in the URL database has been bookmarked and any descriptive tags assigned to specific URLs in the URL database. Then, receiving the query provided by the user that generates search results, where each search result is associated with a URL. The method further includes, before displaying the search results, analyzing each URL of a plurality of the search results to identify if the URL is present in the accessed URL database, and applying overlay data to particular ones of the search results. The overlay data includes information regarding the number of times the URL has been bookmarked and includes particular descriptive tags from the URL database. In another embodiment, a detailed sub-query is associated with each overlay descriptive tag that includes the original query and the overlay descriptive tag.

In another embodiment, a system for generating overlay data to supplement search results obtained as a result of an internet search for a query provided by a user is provided. The system comprises a community bookmark server having user bookmarks, each user bookmark associated with a user universal resource locators (URL) and any user descriptive tags assigned to the user bookmark. The system further comprises a URL database server having processed bookmarks URLs regarding a number of times a user URL has been bookmarked and a normalized count for descriptive tags associated with the user URL, a search server that receives the query and generates search results, each search result associated with a search URL, and an overlay server that analyzes a plurality of search URLs to identify if the search URL is in the URL database, the overlay server applying overlay data to particular ones of search URLs, the overlay data including information regarding the number of times the search URL has been bookmarked and including particular ones of any descriptive tags from the URL database. The system further comprises a display of the user for receiving the search results and overlay data.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 describes a simplified schematic diagram of a network system for implementing embodiments of the present invention.

FIG. 2 depicts the creation of a URL database based on community use data according to one embodiment.

FIG. 3 shows the creation of overlay data using search results and the URL database according to one embodiment.

FIG. 4 shows a screen capture of search results including overlay data for one embodiment of the present invention.

FIG. 5 depicts the process flow for generating overlay data according to one embodiment.

FIG. 6 shows the process flow for generating the URL database according to one embodiment.

FIG. 7 describes the process flow and some examples for normalizing terms according to different embodiments of the present invention.

FIG. 8 shows the detailed process flow for generating overlay data according to one embodiment.

### DETAILED DESCRIPTION

Methods and systems for improving Internet search results by presenting community use data along with search results are disclosed. In one embodiment, community use data is analyzed and overlaid for presentation with the search results, which in turn increase the trust given to the particular search results by users.

As the number of possibilities to access the Internet increases for Internet users, the complexity of managing personal bookmarks associated with their preferred websites grows exponentially. Typically, a user will save favorite websites in the browser of the main system used to access the Internet. To access the favorite websites from other systems, users have to reenter the addresses for their favorite websites, or transfer the list of websites to the new system. This is cumbersome because of the complexity of dealing with different browsers and platforms, and because of security constraints in the different systems.

In one embodiment, a community bookmarking service allows users to keep their favorite bookmarks on a server database that can be accessed from anywhere on the Internet. Users can then add one-word descriptors called “tags” to assist in the identification of the content associated with the target bookmarked website.

Internet users also access Internet search servers to find information. Often, the result of a search includes a list of thousand or millions of websites that contain the terms described in the search query and that may have the information desired. While common Internet search engines have algorithms to prioritize the results and increase the probability that the URL with the best information regarding the search query is listed first, a user may have to inspect many websites until the desired one is found. Sometimes, the user performs subsequent related queries that add new terms to the original query in order to decrease the number of hits and increase the probability that the desired information is found. While the embodiments of this invention are described with the framework of the Internet and Internet search engines, the person skilled in the art will appreciate that the same concepts can be used for other types of networking environments and any type of database searches. For example, the concepts can be applied to sales database queries inside a corporate network.

In one embodiment, methods and systems are provided that enable search engines to access community data from server databases. This community data can then be processed and used to add additional information to search results. This additional information, as discussed below, is referred to as “overlay data.” And, in one embodiment, the overlay data includes bookmark data, and tags. The tags, in one embodiment, may be in the form of active links. In other embodiments, the “overlay data” includes information from other sources besides bookmarking community usage, such as community website ratings, industry website ratings, news websites, etc. The act of adding the overlay data can be referred to as “overlaying,” or “to overlay.”

In some situations, Internet search results may be too broad for the desires of the user. The user can add words to the query to further limit the number of results, or can start exploring the results until the desired information is found. In another embodiment, to facilitate the narrowing of the search results to a given query, the tags function as a “sub-query”. This provides a refinement of the search results. The sub-query is the result of combining the data from the tag with the original query.

The Internet community use data is categorized into a database of URLs that includes the number of times the URL has been bookmarked by the community population and the list of tags that the population may have used to categorize the bookmarked URL. Associated with each tag is a count of the number of times the tag has been used. As noted above, the URL database information is used to enhance the results of an Internet search by adding overlay data to particular URLs found in the search. The overlay data includes the bookmark count for the URL and any descriptive tags associated with the URL, such that the descriptive tags add information to the search results that is non-duplicative, increases diversity and adds relevance.

The following embodiments describe a method, a computer readable medium having program instructions, and a system for generating overlay data to supplement search results obtained as a result of an internet search, where the search results are created for a user provided query.

It will be obvious, however, to one skilled in the art, that the present invention may be practiced without some or all of these specific details. In other instances, well known process operations have not been described in detail in order not to unnecessarily obscure the present invention.

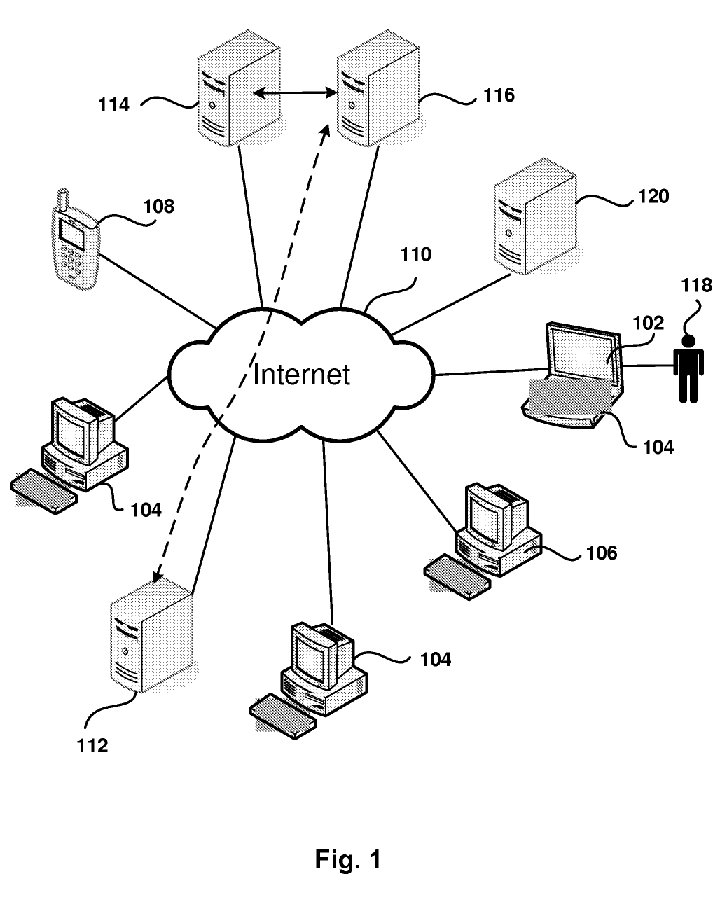

FIG. 1 describes a simplified schematic diagram of a network system for implementing embodiments of the present invention. Internet 110 is used to interconnect users with servers. Users 118 access the Internet 110 via a variety of the devices, such as PCs 104, laptops 106, mobile phones 108, etc. These are merely examples, and any other device used to access Internet 110 can be used to implement embodiments of this invention. For example, the devices may be wired or wireless. In one embodiment, a browser 102 is executed on a device, and the graphical user interface is presented on a display. The browser 102, provides the functionality for accessing the Internet.

In accordance with one embodiment, community bookmark server 112 provides Internet users the ability to bookmark Internet sites for future easy access. The bookmarks are stored into community bookmark server 112 instead of being stored in browser 102 of their local system. This way, bookmarks are always available to Internet users 118, independently of the system used to access Internet 110. Internet users 118 have the option of storing descriptive tags with their bookmarks to provide additional information about the bookmarked URL. Community bookmark server 112 can provide additional services, such as showing information about popular or interesting websites. An example of a community bookmarking service available today is del.icio.us™, but the embodiments of this invention are not construed to this service and can be used in conjunction with any other community bookmarking service.

URL database server 116 uses the individual bookmarking information from community server 112 to create a URL database that reflects how internet users 118 bookmark and tag websites. Search server 114 provides search services to Internet users. Overlay server 120 enhances the search results from queries to search server 114 by using the information from URL database server 116, and thus creates overlay data that is added to the search results. Although four different servers are described by way of example, the person skilled in the art will appreciate that multiple configurations are possible by combining several servers into one system, by having distributed systems where a single function can be accomplished by a plurality of different servers scattered across the Internet, or by caching information from the different databases at the different servers to accelerate the processing of information.

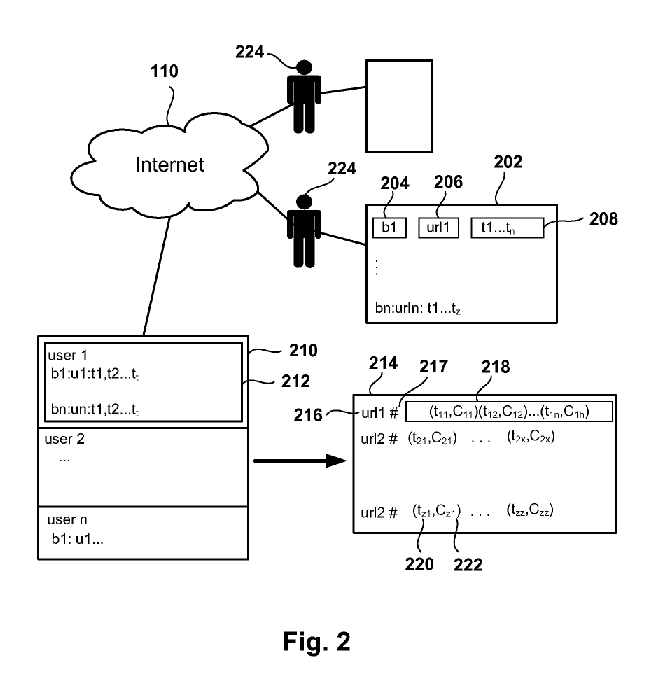

FIG. 2 depicts the creation of the URL database 214 based on community use data. As users 224 bookmark websites using community bookmark server 112 shown in FIG. 1, user bookmark table 202 is created containing a list of bookmarks 204. Each bookmark 204 is associated with URL 206 and a list of descriptive tags 208, if user 224 entered descriptive tags for bookmark 204. The community bookmark server 112 holds the information for all users in the community bookmark table 210. Each entry in the community bookmark table 210 holds user data 212 that corresponds to the information in user bookmark table 202.

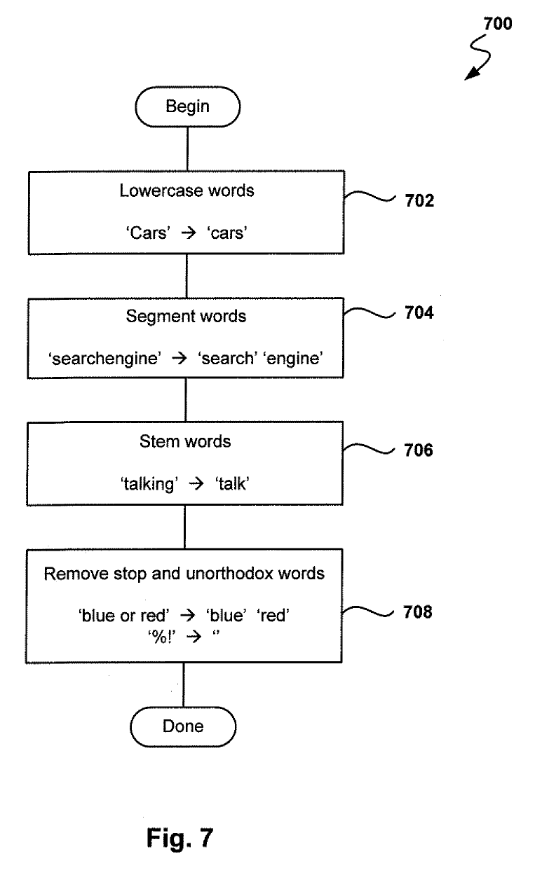

Information from community bookmark table 210 is used to create URL database 214 that has one entry per URL. Each entry has processed URL 216, count 217 of the number of times processed URL 214 has been bookmarked, and tag list 218 that includes descriptive tags 220 added by users with tag count 222 of the number of times the tag has been used. URLs 206 go through a normalization process to create processed URLs 216 because there can be several URLs that refer to the same website. Consequently, those URLs 206 that refer to the same website are aggregated into just one processed URL 216 by selecting a representative URL and associating a tag list 218 with that URL that accounts for all the tags from the aggregated URLs. The tags in community bookmark table 210 go through a process of cleaning and normalization before the data is consolidated. This process, described in more detail below with respect to FIG. 7, assists in the identification of tags that are similar but not identical, improper tags, or tags that are a composite of two or more words.

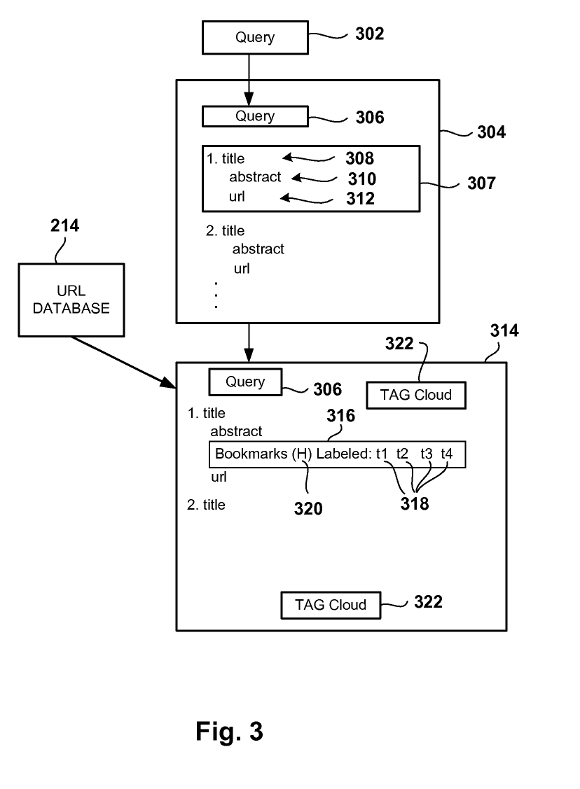

FIG. 3 shows the creation of overlay data 316 using search results 304 and URL database 214. Initially, a query 302 is submitted to a search server 114, as seen in FIG. 1, with a list of terms and occasionally logical operators, which identify the desired parameters for the search. Search server 114 generates search results 304. Included here is a simplified representation of the search results, and the person skilled in the art will appreciate that additional information may be included with the search results, such as suggestions for related queries, sponsored website information, links to additional search results, size of page referenced by the URL, cached versions of the website, maps or links to maps, advertisements, links to other services offered by the search provider, etc.

Search results 304 include query 306 that originated the search, and a plurality of website search results 307. Each website search result 307 includes title 308, abstract 310, and URL 312. Title 308 is a one-line description of the content found on the website. Abstract 310 contains information that has been parsed by search server 114 from the website to provide a more detailed description of the content than the one provided by title 308. The third component of website search result 307 is URL 312 with the Internet address of the website.

In one embodiment, URL database 214 is used to add overlay data 316 to the website search results 307. Overlay data 316 includes number of times bookmarked 320 and set of descriptive tags 318. Number of times bookmarked 320 indicates how many times the users of the community bookmarking service have bookmarked this particular website, and descriptive tags 318 show some of the tags used by the community bookmarking community. In one embodiment, overlay data 316 is inserted between abstract 310 and URL 312 with the following format: the word “Bookmarks” followed by number times bookmarked 320 in parenthesis, the word “Labeled” and a colon symbol, and four descriptive tags 318 with a hyphen separating the descriptive tags. Other configurations for the overlay data are possible, such as inserted between title 308 and abstract 310, after URL 312, concatenated at the end of abstract 310, etc. Furthermore, the overlay data does not have to be contiguous. For example, number times bookmarked can be appended to the title and descriptive tags 318 can be appended to URL 312.

Overlay data 316 can be further refined by associating descriptive tags 318 with sub-queries. In one embodiment, each descriptive tag 318 is presented as a link that generates a sub-query, formed by complementing the original query with a new term to be found in the search, where the new term is the descriptive tag 318.

In one embodiment, a tag cloud can be included at the top and/or bottom of the page if there are enough descriptive tags 318 in all the overlay data 316 from all the individual website search results 307. A tag cloud (or weighted list in visual design) is a visual depiction of content tags used on a website. Tags are typically listed alphabetically, and tag frequency is shown with font size or color, thus both finding a tag by alphabet and by popularity is possible. The tags are usually hyperlinks that lead to a collection of items that are associated with that tag. To determine if there are enough tags to form a cloud, a minimum number of different descriptive tags is required. In one embodiment, ten or more different tags are required to display the tag cloud. The sub-queries for the tag cloud are formed also by adding the original query to each of the terms in the tag cloud.

Overlay data can also be personalized. For example, in one embodiment, a user may select to get overlay data only from her bookmarks in the community bookmarking service. In another embodiment, the user may choose to get overlay data only from his bookmarks and from his friend's bookmarks, where the friends are those selected by the user in the community bookmarking service to be his friends.

In some community bookmarking services, the user can also write personal notes for that particular website, and often those notes will have a description of the website. In one embodiment, user notes are added to the overlay data. This allows another level of information that allows users to better identify the contents of a website found during a search query.

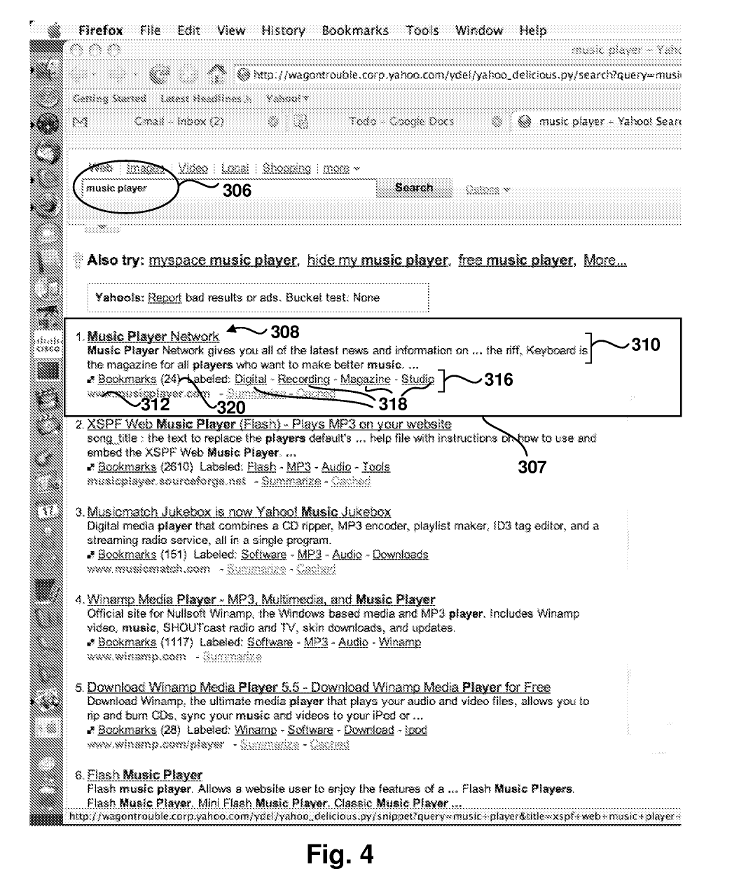

FIG. 4 shows a screen capture of search results including overlay data for one embodiment of the present invention. Here, query 306 is found at the top, and website results 307 include title 308 in the first line, followed by abstract 310, overlay data 316, and URL 312. In this example, the query is for “music player.” The first website result 307 has the title “Music Player Network” followed by abstract 310 of this website with a URL 312 of www.musicplayer.com, as seen in the last line of website search result 307. Overlay data 316 indicates that the www.musicplayer.com website has been bookmarked 24 times by users of the del.icio.us™ community bookmarking service, and that the tag selection algorithm has chosen the tags “Digital,” “Recording,” “Magazine,” and “Studio.” Tags provide context information that allows users to quickly identify information about the website. Besides the information provided in title 308 and abstract 310, the user has now new information related to this website as provided by the tags “Digital,” “Recording,” “Magazine,” and “Studio.”

In another embodiment, descriptive tags 318 are shown as links and may be associated with sub-queries. For example, if the user selected the tag “Digital,” then a new search would take place for “music player digital” as a result of concatenating the original query “music player” with the tag “Digital.”

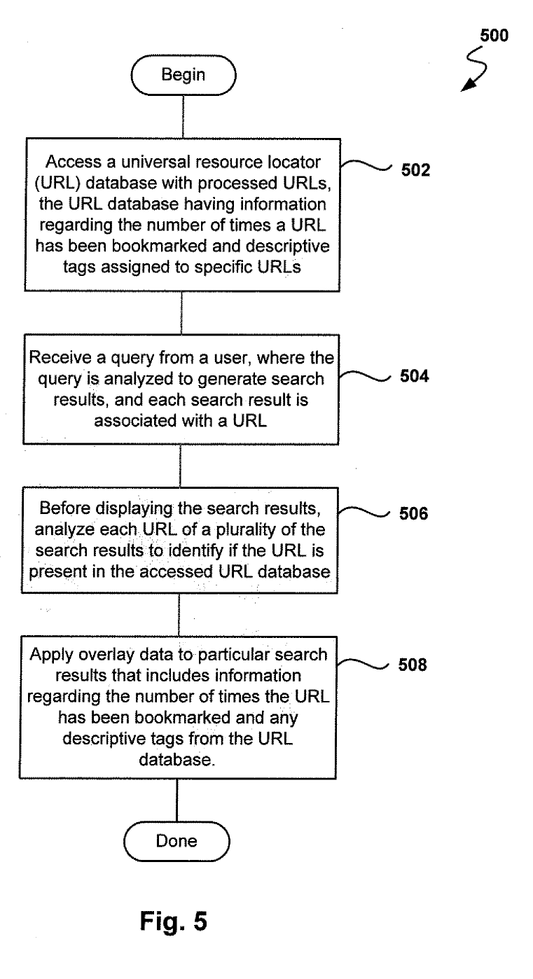

FIG. 5 depicts the process flow for generating overlay data according to one embodiment. In operation 502, a database with processed URLs is accessed, where the database contains information regarding the number of times a URL has been bookmarked by users of a community bookmarking service, and descriptive tags that the users of the community bookmarking service have assigned to the URL.

In operation 504, a query from a user is received to perform a search. The search produces search results, where each of the search results points to a website identified by its URL. After the search is performed, and before displaying the results to the user, a plurality of the search results are analyzed to check if the URL found is in the URL database. In one embodiment, the plurality of search results analyzed corresponds to the websites displayed in the first page of the web results. In another embodiment, a fix number of URLs are analyzed, such as the top twenty.

Following the analysis of the search results, overlay data is applied to particular search results in operation 508. The overlay data includes the number of times the URL has been bookmarked by users of the community bookmarking service, and descriptive tags chosen from the tags associated with that URL in the URL database. In another embodiment, sub-queries are associated with the descriptive tags as discussed previously.

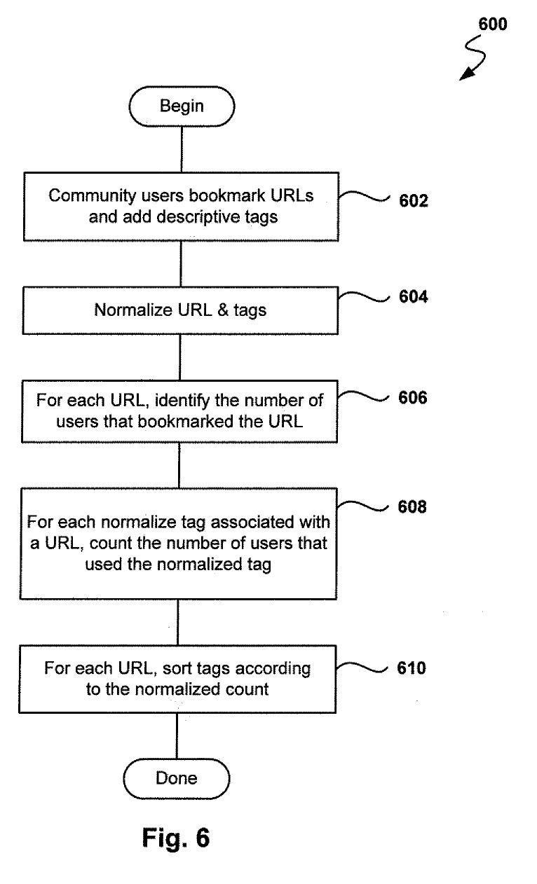

FIG. 6 shows the process flow for generating the URL database according to one embodiment. In operation 602, the users of the community bookmarking service bookmark URLs, and optionally add tags descriptive of the URL. Before consolidating all the bookmark information, the URLs and tags assigned by users are normalized in operation 604 to provide consistency in the use of URLs and tags and to facilitate the consolidation of the tag counts. The URL normalization process consists of identifying those URLs that refer to the same website and combining them under a representative URL entry in the database. The tag normalization process refers to a process for standardizing the use of tags. This process can for example, consolidate tags that have the same stem, convert all tags to lowercase characters, eliminate strange words, etc. A tag normalization process for one embodiment is described below with respect to FIG. 7.

Once the URL and tags are normalized, the number of users that have bookmarked each URL is counted in operation 606. A database with community bookmarking information is accessed. The database contains, among other information, the URLs that users in the community have bookmarked. The database is parsed to see how many users have bookmarked the particular URL, and a count is associated with that URL. If the normalized URL has been consolidated from combining several URLs, then the count associated with the normalized URL will be the sum of the individual counts for the URLs being combined. In operation 608, the normalized tags associated with the URL are counted. The database with community bookmarking information is parsed to count how many times each normalized tag has been used for a given URL. The tags for the normalized URL are the tags from all the URLs being combined and the tag count for each tag is the sum of the tag counts in the URLs being combined. In operation 610 the tags associated with each URL are sorted according to tag count.

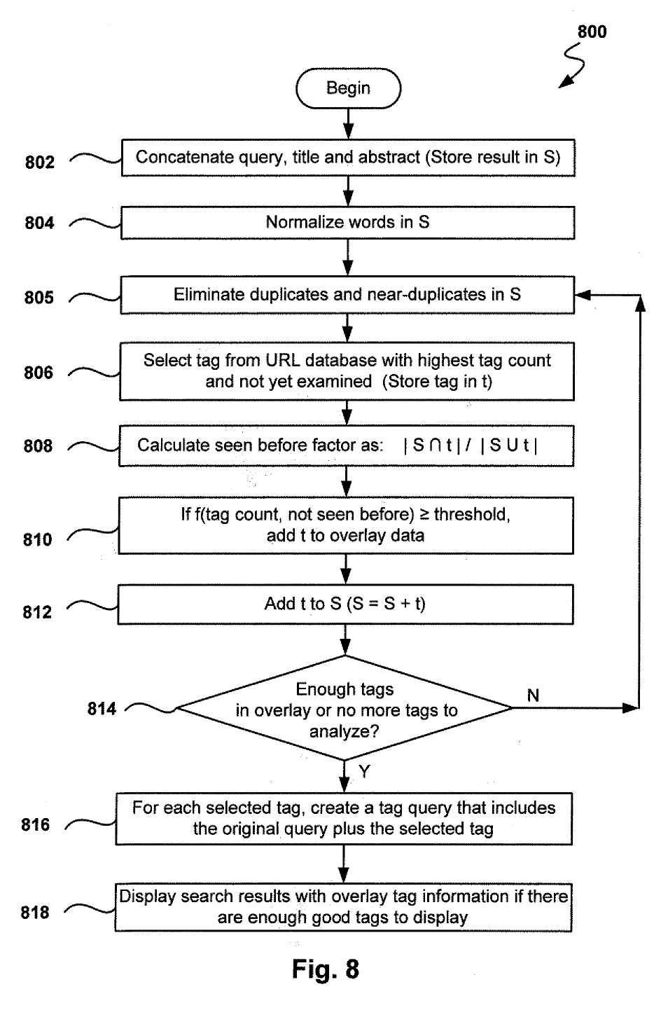

FIG. 7 describes the process flow and some examples for normalizing terms according to different embodiments of the present invention. Normalizing terms can take place during different operations. In one operation, the tags are normalized when consolidating community use data in the URL database, as seen in operation 604 in FIG. 6. In another embodiment, terms are normalized during the creation of the overlay data, as seen operation 804 in FIG. 8. The person skilled in the art will appreciate that the operations described here are by way of example, where one or more of the normalizing operations described here could be omitted, and other normalizing operations could be added to further define the use of terms for particular implementations.

In operation 702, terms are converted to lowercase. For example, the terms ‘Cars,’ ‘CARS,’ ‘CArs’ and ‘cars’ are normalized as ‘cars.’ In operation 704, terms that consist of a plurality of words are segmented into separate terms. For example, the term ‘searchengine’ normalizes into two separate terms, ‘search’ and ‘engine.’ In stemming operation 706, terms with the same word stem are converted to a representative term for the whole class with the same stem. For example, ‘talking,’ ‘talked,’ ‘talks,’ and ‘talk’ all are normalized to the term ‘talk.’

During operation 708, stop words and unorthodox or invalid words are removed. Stop words, or stopwords, is the name given to words which are filtered out prior to, or after, processing of natural language data (text). In computer search engines, a stop word is a commonly used word (such as “the”) that a search engine has been programmed to ignore, both when indexing entries for searching and when retrieving them as the result of a search query. For example, the string ‘blue or red’ will result in two normalized terms: ‘blue,’ and ‘red.’ Additionally, in operation 708 words with special characters and strange words are discarded. For example, the terms ‘%!,’ ‘cooooooooo1’ and ‘axe43’ would be discarded.

FIG. 8 shows the detailed process flow for generating overlay data according to one embodiment. In operation 802, for each of the website search results 307 as seen in FIG. 3, query 302 is concatenated with title 308 and abstract 310. For descriptive purposes, the concatenated string is named S. The resulting S string from the concatenation in operation 802 is normalized in operation 804. In operation 805, duplicate and near-duplicate terms in S are eliminated to avoid redundancy and increase diversity. There are two types of duplicates that are eliminated. First, words that represent the same word but are spelled differently are eliminated, for example ‘drink’ and ‘drinking.’ The terms in S are stemmed, causing both terms to be represented by the same word; therefore, they will be detected as duplicates when the terms are compared. Second, the semantics of the terms are compared to check if they represent the same concept, such as for example ‘search’ and ‘find.’ This semantic duplication can be detected by checking their meanings in a Thesaurus, or by examining their co-frequencies in a large set of documents.

In operation 806, the descriptive tag 220 with the highest tag count 222 that hasn't been analyzed yet is selected for analysis. By analyzing tags according to their count, the overlay data will include tags that are popular among the users in the community bookmarking community.

In operation 808, tags are searched to increase the diversity of the search results. If a tag appears already several times in query, title or abstract, it will be less likely to be chosen for the overlay data in order to increase the diversity of the information added in the overlay data to the search results. In one embodiment, the words in query, title and abstract are given different weights to calculate the diversity factor for adding a particular tag to the overlay data. For example, a tag already in the query will have a very small possibility to be included as an overlay tag.

In one embodiment, the diversity is measured by the seen before factor that is calculated as the ratio between the number of elements in the set formed by the intersection of S and the tag being analyzed, and the number of elements in the set formed by the union of S and the tag being analyzed. In operation 810, the popularity of the tag as measured by its tag count, is combined with the ‘not seen before’ factor to calculate a desirability factor. If the desirability factor is equal or bigger than a predetermined threshold, then the tag is added to the overlay data. This way, tags are added that increase diversity to the already found search results and that reflect the popularity as indicated by the tag count. In one embodiment, the desirability factor is calculated by multiplying a weighted tag count by a weighted inverse of the seen before factor.

After analyzing a tag, the tag is added to string S in operation 812 to avoid adding similar tags later on. In operation 814, it is determined if there are have enough tags for the overlay data. Determining how many tags is enough depends on the implementation. For example, in one embodiment just one tag is considered enough, while in another embodiments the minimum number of tags can be two, three, four, etc. If there are not enough tags the process goes back to operation 806 to continue analysis with the next tag, unless all the tags for the URL have already been analyzed. The number of tags in the overlay data can vary. In one embodiment, four tags are included in the overlay data. If there are enough tags for the overlay data, the process continues on to operation 816 that creates sub-queries for each tag in the overlay data. In one embodiment, the number of tags is limited by the space available. For example, if the tags do not fit in one line, then tags are eliminated so the overlay data can fit in one line.

In operation 818, it is determined whether there are enough good tags to display in the overlay data, that is, if there is a prescribed minimum of tags that have passed the inclusion criteria describe above. If there are enough good tags, the results with the overlay data are shown to the user.

With reference to FIG. 1, a client system might include a desktop personal computer, workstation, laptop, PDA (personal digital assistant), cell phone, any wireless application protocol (WAP) enabled device or any other computing device capable of interfacing directly or indirectly to the Internet. A client system typically runs a browser program, such as Microsoft's Internet Explorer™ browser, Netscape Navigator™ browser, Mozilla™ browser, Opera™ browser, a WAP-enabled browser in the case of a cell phone, a PDA or other wireless device, allowing a user of a client system to access, process and view search results available to it from information servers over Internet 110. A client system might also include one or more user interface devices, such as a keyboard, a mouse, a roller ball, a touch screen, a pen or the like, for interacting with a graphical user interface (GUI) provided by the browser on a display (e.g., monitor screen, LCD display, etc.), in conjunction with pages, forms, and other information provided by information servers.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A computer implemented method for generating overlay data to supplement search results obtained as a result of an internet search, the search results being for a query provided by a user, comprising:
accessing a universal resource locator (URL) database having URLs that are processed, the URL database having information regarding a number of times a URL in the URL database has been bookmarked and any descriptive tags assigned to specific URLs in the URL database;
receiving the query provided by the user, the query being analyzed to generate the search results, each search result being associated with a URL;
before displaying the search results, analyzing at least one URL of a plurality of the search results to identify if the URL of the plurality of search results is present in the accessed URL database; and
applying overlay data to particular ones of the search results, the overlay data including the information regarding the number of times the URL has been bookmarked and including particular ones of any descriptive tags from the URL database.

2. The computer implemented method as recited in claim 1, wherein the URL database is constructed from community use data, the community use data includes bookmarking indication data and words that operate as the descriptive tags for the specific URLs in the URL database.

3. The computer implemented method as recited in claim 1, further comprising,
executing a cleaning operation on the descriptive tags assigned to the specific URLs before adding the descriptive tags to the URL database, wherein the cleaning operation includes normalizing the descriptive tags and assigning a normalized count for each of the descriptive tags that were normalized, and
sorting the normalized descriptive tags according to the normalized count.

4. The computer implemented method as recited in claim 1, wherein analyzing at least one URL of the plurality of the search results to identify if the URL of the plurality of search results is present in the accessed URL database further includes performing a cleaner operation, the cleaner operation including,
identifying the query; and
identifying a title and abstract for the URL of the plurality of search results.

5. The computer implemented method as recited in claim 4, wherein the cleaner operation further includes,
concatenating text for each of the query and the title and abstract for the URL of the plurality of search results;
splitting words of the concatenated text for each of the query and the title and abstract;
normalizing the words; and
unique processing the normalized words to eliminate duplicate and near-duplicate words.

6. The computer implemented method as recited in claim 5, wherein the overlay descriptive tags are defined from the normalized words that remain after the unique processing and any descriptive tag assigned to the analyzed URL in the URL database, and each descriptive tag is associated with a tag count.

7. The computer implemented method as recited in claim 6, wherein the overlay descriptive tags provide information that is processed to be substantially non-duplicative of information provided by the query, title and abstract.

8. The computer implemented method as recited in claim 6, wherein the overlay descriptive tags provide information that substantially increase diversity and relevance of the displayed results.

9. The computer implemented method as recited in claim 7 wherein the words from query, title and abstract are given different weights when defining the overlay descriptive tags.

10. The computer implemented method as recited in claim 9 wherein the overlay descriptive tags are defined based on the ratio between the number of words in common between the normalized words that remain after the unique processing and any descriptive tags assigned to the analyzed URL, divided by the number of unique words in the union of the normalized words that remain after the unique processing and the any descriptive tags assigned to the analyzed URL.

11. The computer implemented method as recited in claim 1, further comprising,
associating a sub-query to each overlay descriptive tag, the sub-query including the original query and the overlay descriptive tag.

12. The computer implemented method as recited in claim 5, wherein the normalizing the words further comprises,
lowercasing the words,
segmenting the words,
stemming the words,
removing stopwords from the words, and
eliminating unorthodox words.

13. The computer implemented method as recited in claim 1, further comprising displaying a tag cloud with the search results.

14. A computer readable medium having program instructions for generating overlay data to supplement search results obtained as a result of an internet search, the search results being for a query provided by a user, comprising:
program instructions for accessing a universal resource locator (URL) database having URLs that are processed, the URL database having information regarding a number of times a URL in the URL database has been bookmarked and any descriptive tags assigned to specific URLs in the URL database;
program instructions for receiving the query provided by the user, the query being analyzed to generate the search results, each search result being associated with a URL;
program instructions for before displaying the search results, analyzing at least one URL of a plurality of the search results to identify if the URL of the plurality of search results is present in the accessed URL database; and
program instructions for applying overlay data to particular ones of the search results, the overlay data including the information regarding the number of times the URL has been bookmarked and including particular ones of any descriptive tags from the URL database.

15. The computer readable medium having program instructions as recited in claim 14, wherein analyzing at least one URL of the plurality of the search results to identify if the URL of the plurality of search results is present in the accessed URL database further includes program instructions for performing a cleaner operation, the cleaner operation including,
program instructions for identifying the query; and
program instructions for identifying a title and abstract for the URL of the plurality of search results.

16. The computer readable medium having program instructions as recited in claim 15, wherein the cleaner operation further includes,
program instructions for concatenating text for each of the query and the title and abstract for the URL of the plurality of search results;
program instructions for splitting words of the concatenated text for each of the query and the title and abstract;
program instructions for normalizing the words; and
program instructions for unique processing the normalized words to eliminate duplicate and near-duplicate words.

17. The computer readable medium having program instructions as recited in claim 16, wherein the overlay descriptive tags are defined from the normalized words that remain after the unique processing and any descriptive tag assigned to the analyzed URL in the URL database, and each descriptive tag is associated with a tag count.

18. The computer readable medium having program instructions as recited in claim 14 further comprising,
program instructions for associating a sub-query to each overlay descriptive tag, the sub-query including the original query and the overlay descriptive tag.

19. A system for generating overlay data to supplement search results obtained as a result of an internet search, the search results being for a query provided by a user, comprising:
a community bookmark server having user bookmarks, each user bookmark associated with a user universal resource locators (URL) and any user descriptive tags assigned to the user bookmark;
a URL database server having processed URLs regarding a number of times a user URL has been bookmarked and a normalized count for descriptive tags associated with the user URL;
a search server that receives the query and generates search results, each search result associated with a search URL;
an overlay server that analyzes a plurality of search URLs to identify if the search URL is in the URL database, the overlay server applying overlay data to particular ones of search URLs, the overlay data including information regarding the number of times the search URL has been bookmarked and including particular ones of any descriptive tags from the URL database; and
a display of the user for receiving the search results and overlay data.

20. The system for generating overlay data as recited in claim 19, wherein the normalized count is calculated by adding the number of times a normalized descriptive tag has been bookmarked by a user, wherein normalizing the descriptive tags includes,
lowercasing the tags,
segmenting the tags,
stemming the tags,
removing stopwords from the tags, and
eliminating unorthodox tags.

21. The system for generating overlay data as recited in claim 19, wherein each processed URL consolidates the data from several user URLs if the several user URLs refer to the same website.

22. The system for generating overlay data as recited in claim 19 wherein the descriptive tags in the overlay data are associated with a sub-query that includes the original query and the overlay descriptive tag.
